(19) United States
(12) Patent Application Publication
(10) Pub. No.: US 2010/0234969 A1
(43) Pub. Date: Sep. 16, 2010

(54) PROCESS MANAGEMENT SYSTEM

(75) Inventor: Nagahiro Inoue, Shizuoka (JP)

Correspondence Address: CANTOR COLBURN, LLP, 20 Church Street, 22nd Floor, Hartford, CT, 06103, US

(73) Assignee: ULVAC, INC., Kanagawa (JP)

(21) Appl. No.: 12/664,490

(22) PCT Filed: Jun. 6, 2008
(86) PCT No.: PCT/JP2008/060437

§ 371 Date: Jun. 1, 2010

(30) Foreign Application Priority Data
Jun. 12, 2007 (JP) 2007-154730

(51) Int. Cl. G05B 11/01

(52) U.S. Cl. 700/12; 700/17

(57) ABSTRACT

It is possible to provide a process management system which can rapidly analyze information obtained by a plurality of devices. The system includes: first acquisition means (a control monitor unit (20)) which acquires state information including a state of each component of a plurality of devices; second acquisition means (control monitor unit (20)) which acquires control information on control of the devices; adjusting means (CPU (2a)) which makes adjustment so that the acquired state information and the control information have a cycle which is predetermined for each of the devices; correlation means (the control monitor unit (20), a timer (34)) which correlates the state information with the control information; storage means (HDD (2d)) which stores the correlated state information and the control information; analysis means (CPU (4a)) which executes a predetermined analysis process on the state information by referencing the control information; and display means (a display device (4h)) which displays the information obtained as a result of the analysis by the analysis means.

### FIELD OF THE INVENTION

The present invention relates to a process management system.

### BACKGROUND ART

In recent years, it has become popular to manufacture objective workpieces by using a process system equipped with multiple chambers, for example, as disclosed in Patent Document 1 and Patent Document 2.

Patent Document 1: JP H11-506499 A (Claims and Abstract)

Patent Document 2: JP 2006-294911 A (Claims and Abstract)

### DISCLOSURE OF INVENTION

### Subjects to be Solved

In a conventional process system, an analog waveform showing a state inside a chamber, for example, is sampled and the waveform data is stored in a storage device. Then, in a case where any defect is found in an objective workpiece, a cause of the defect is analyzed according to information, stored in the storage device, corresponding to the objective workpiece.

However, such analyzing work is carried out manually, and accordingly, there appears a problem that the analyzing work takes much time. Furthermore, in connection with a fact that process accuracy has been increased in late years, even a small difference in a process greatly affects performance of an objective workpiece. Accordingly, there exists a problem that it takes a lot of time to manually detect such a small difference from an analog waveform.

Moreover, in a case of a system that includes a plurality of chambers of analysis objects as Patent Documents 1 and 2 show, there is also a problem that much more time is needed for analyzing work. Incidentally, in the case of such a system, information on dynamic state or a processed result with respect to each chamber is saved, but no analog waveform is stored.

It is an object of the present invention to provide a process management system that can quickly analyze information from a process system including a plurality of chambers.

### Means to Solve the Subject

To achieve the object described above, a process management system according to the present invention includes: a first acquisition means for acquiring state information showing a state of each part of a plurality of devices, a second acquisition means for acquiring control information relating to control of the plurality of devices, an adjustment means for adjusting a cycle period of the state information and the control information acquired by the first acquisition means and the second acquisition means respectively to become the same as a cycle period predefined for each device in advance, a correlation means for correlating the state information with the control information acquired by the first acquisition means and the second acquisition means respectively, a storage means for storing the state information and the control information that have been correlated each other by the correlation means, an analysis means for executing prescribed analysis on the state information with reference to the control information, and a presentation means for presenting information obtained as a result of the analysis by the analysis means. Therefore, information obtained from a process system including a plurality of chambers can be analyzed quickly.

In addition to the aspect of the invention described above, the correlation means may correlate the state information with the control information while providing the state information and the control information with a time stamp individually. Therefore, by using the time stamp, the state information can be correlated easily with the control information.

In addition to the aspect of the invention described above, the adjustment means may make an adjustment for the state information through decimation on the information so as to provide the cycle period predefined, and an adjustment for the control information on its time stamp so as to provide the cycle period predefined. Therefore, it becomes possible to make an adjustment for the acquisition timing of the state information and the control information generated at various cycle periods.

In addition to the aspect of the invention described above, the first acquisition means may acquire the state information with a first cycle period when a semiconductor process device is in execution, and acquire the with a second cycle period longer than the first cycle period when the semiconductor process device is not in execution. Accordingly, a required storage area of the storage means can be reduced.

In addition to the aspect of the invention described above, the analysis means may execute extraction of a predefined piece of the state information by using a predefined piece of the control information as a trigger, and the presentation means may present a predefined piece of the state information extracted by the analysis means. Therefore, an objective piece of the state information can be easily found.

In addition to the aspect of the invention described above, the analysis means may execute extraction of a predefined piece of the state information by using a predefined piece of the control information as a trigger, and also execute calculation of a time when the predefined piece of the state information extracted meets a predefined condition, and the presentation means may present the time extracted by the analysis means. Therefore, time-wise information can be acquired according to the state information.

In addition to the aspect of the invention described above, the analysis means may execute extraction of a predefined piece of the state information by using a predefined piece of the control information as a trigger, and also execute calculation of at least one of a maximum value, a minimum value, an average, and a medium value of the predefined piece of the state information extracted, and the presentation means may present the value extracted by the analysis means. Accordingly, various kinds of information can be acquired according to the state information.

In addition to the aspect of the invention described above, the storage means may store semiconductor substrate identifying information for identifying a semiconductor substrate as a processing object of the semiconductor process device together with at least one of the control information and the state information, and the analysis means may execute the analysis with reference to the semiconductor substrate identifying information as well. Therefore, it is possible to notice a change of each substrate in the state information with reference to the semiconductor substrate identifying information.

In addition to the aspect of the invention described above, the semiconductor substrate identifying information may include at least information for identifying a substrate lot of the semiconductor substrate as well as information for identifying a processing order within the lot, and the analysis means may execute the analysis with reference to the information for identifying the substrate lot of the semiconductor substrate as well as the information for identifying the processing order within the lot. Accordingly, it is possible to notice a change in the state information for each lot.

In addition to the aspect of the invention described above, the storage means may store device identifying information for identifying the plurality of devices together with at least one of the control information and the state information, and the analysis means may execute the analysis with reference to the device identifying information as well. Therefore, it is possible to notice a change in the state information for each device.

### EFFECT OF THE INVENTION

According to the present invention, it becomes possible to provide a process management system that can quickly analyze information acquired from a device.

### BRIEF DESCRIPTION OF DRAWINGS

FIG. 1 is a block diagram showing an example of a configuration of a process management system according to an embodiment of the present invention.

FIG. 2 is a block diagram showing an example of a configuration of a plurality of process devices shown in FIG. 1

FIG. 3 is a block diagram showing an example of a configuration of a process device shown in FIG. 1

FIG. 4 is a block diagram showing an example of a configuration of a log storage device shown in FIG. 1

FIG. 5 is a block diagram showing an example of a configuration of an analysis device shown in FIG. 1

FIG. 6 is a flowchart showing an example of a procedure for generating event data in a process device 1-3 shown in FIG. 3.

FIG. 7 shows an example of the event to be executed in the process device 1-3 shown in FIG. 3.

FIG. 8 shows an example of an event to be executed in a process device 1-1.

FIG. 9 shows an example of event data generated through a process of the flowchart shown in FIG. 6.

FIG. 10 is a flowchart showing an example of a procedure for generating trace data in the process device 1-3 shown in FIG. 3.

FIG. 11 shows an example of trace data generated through the procedure of the flowchart shown in FIG. 5.

FIG. 12 is a flowchart explaining an example of a process to be executed in the log storage device.

FIG. 13 is an example of event data generated by the process device 1-1.

FIG. 14 is an example of the event data shown in FIG. 13 after adjusting a time stamp of the data.

FIG. 15 is an example of the trace data generated by the process device 1-3.

FIG. 16 is an example of the trace data shown in FIG. 15 after decimation of the data.

FIG. 17 is a flowchart explaining an example of a procedure to be executed in the analysis device.

FIG. 18 is an example of a correlated combination of event data and trace data.

FIG. 19 is another example of a correlated combination of event data and trace data.

FIG. 20 is an example of a graph showing a result of analysis on a display device.

FIG. 21 shows an example of a configuration of another embodiment according to the present invention.

### REFERENCE NUMERALS

1. Process Device, 2. Log Storage Device, 2a. CPU (adjusting means), 2d. HDD (storage means), 3. Network, 4. Analysis Device, 4a. CPU (analysis means), 4h. Display Device (presentation means), 12. Wafer (objective workpiece), 20. Control Monitor Unit (first acquisition means, second acquisition means, and part of correlation means), 34. Timer (part of correlation means)

### BEST MODE FOR CARRYING OUT THE INVENTION

An embodiment according to the present invention will be described below with reference to the accompanying drawings. An explanation below is made in order of, (A)

Example of Configuration of Embodiment, (B) Outline of Operation of Embodiment, (C) Detailed Operation of Embodiment, and (D) Modification of the Embodiment.

(A) Example of Configuration of Embodiment

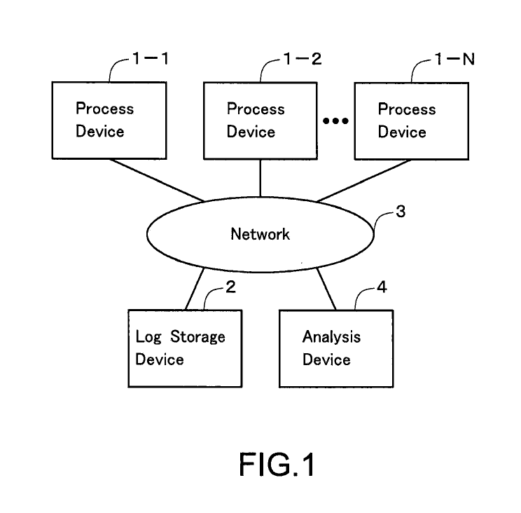

FIG. 1 shows an example of a configuration of a process management system according to an embodiment of the present invention. As shown in the drawing, the process management system includes, as its key constituents: N sets of process devices 1-1 to 1-N (wherein N is greater than 1), a log storage device 2, a network 3, and an analysis device 4.

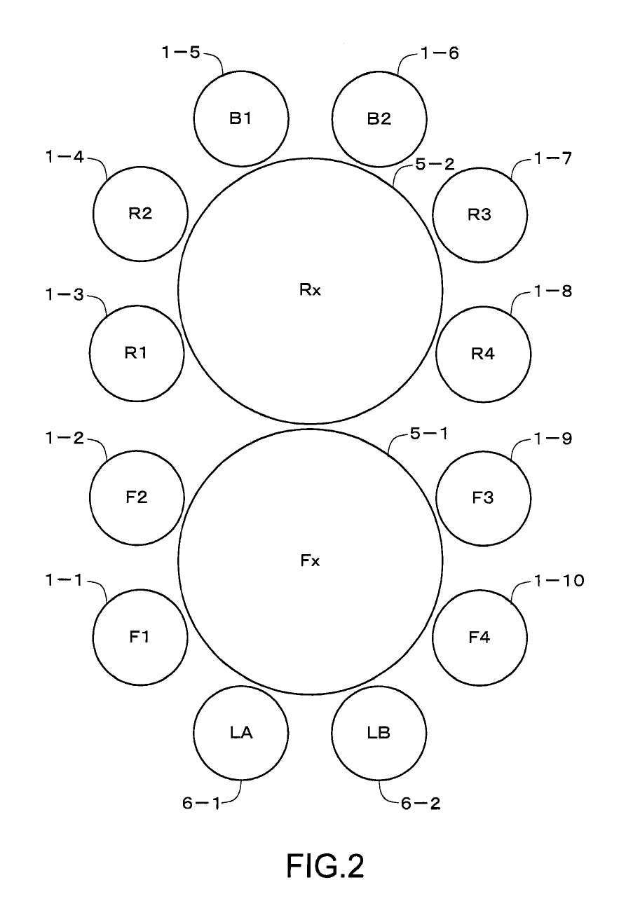

The process devices 1-1 to 1-N are, for example, a PVD (Physical Vapor Deposition) device, a CVD (Chemical Vapor Deposition), an etching device, an implantation device, a photolithography device, and the like. FIG. 2 shows an example of the process devices 1-1 to 1-N in the present embodiment. The example includes 10 sets of process device 1-1 to 1-10 (N=10). In the example, the process device 1-1 is e.g., a process device for annealing. The process device 1-2 is a PVD device for forming a tantalum thin film on a wafer. Meanwhile, the process device 1-3 is a PVD device for forming a copper thin film on a wafer. The process device 1-5 is configured for degassing operation. Then, process devices 1-10, 1-9, 1-8, and 1-6 are configured in the same way as the process devices 1-1, 1-2, 1-3, and 1-5, respectively. In this example, process devices 1-4 and 1-7 are not used.

A stocker 6-1 stores a wafer unprocessed, while a stocker 6-2 stores a wafer processed. Each of transfer devices 5-1 and 5-2, which mainly includes a grasping part (not shown) and a rotary section (not shown) for turning the grasping part to an arbitrary direction within a 360-degree directional range, takes out a wafer stored in the stocker 6-1 and transfers the wafer into a chamber of each process device. Then, after execution of processing operations for the wafer, the transfer device makes the transfer device 6-2 store the processed wafer. A wafer as a processing object is taken out at first from the stocker 6-1 by the transfer device 5-1, and then an annealing process is executed in the process device 1-1. Next, a process for forming a tantalum thin film is executed in the process device 1-2, and a process for cooling the wafer is executed in the process device 1-5. Subsequently, a process for forming a copper thin film is executed in the process device 1-3, and finally the wafer is stored in the stocker 6-2. The same operations are also executed in the process devices 1-6 to 1-10. More specifically, for a wafer taken out from the stocker 6-1 by the transfer device 5-1, anneal processing is executed in the process device 1-10. Next, a process for forming a tantalum thin film is executed in the process device 1-9, and a process for cooling the wafer is executed in the process device 1-6. Subsequently, a process for forming a copper thin film is executed in the process device 1-8, and finally the wafer is stored in the stocker 6-2.

The explanation continues with reference to FIG. 1 again. The log storage device 2 acquires log data, generated in the process devices 1-1 to 1-10, through the network 3 and then, after adjusting the data for each process device, stores the log data. Afterward, when the analysis device 4 makes a demand, the log storage device 2 transmits saved log data accordingly through the network 3.

The network 3, which may be configured, for example, with a LAN (Local Area Network) or an equivalent, electrically connects the process devices 1-1 to 1-10, the log storage device 2, and the analysis device 4 one another so as to enable information and telecommunication among the devices and devices, for example, with packet communication.

The analysis device 4, which may be configured, for example, with a personal computer or the like, acquires the log data stored in the log storage device 2 through the network 3, and executes various operations of analysis.

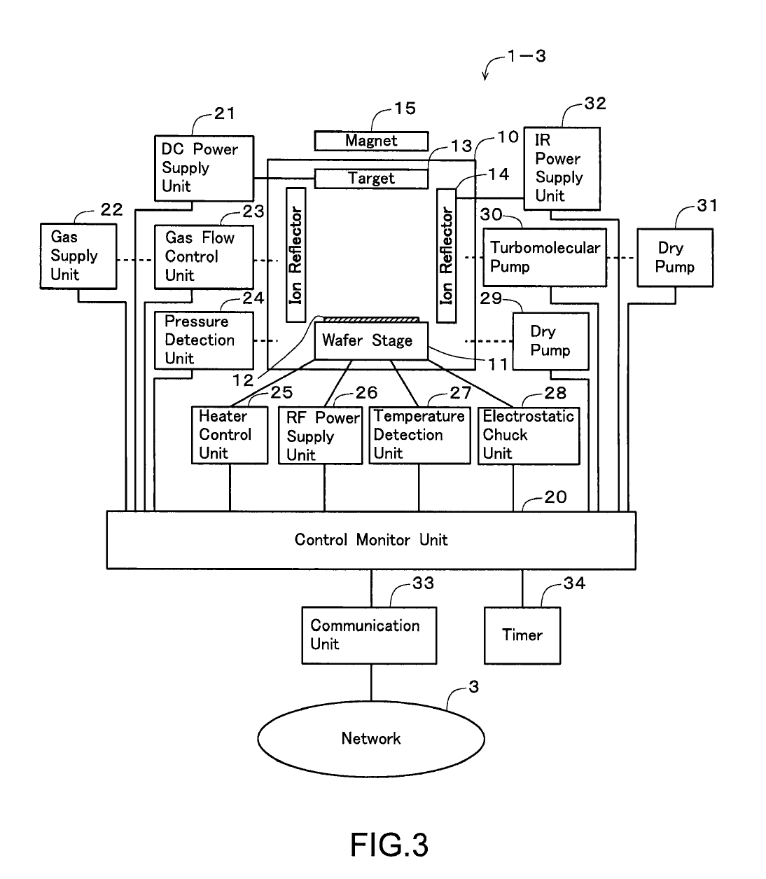

FIG. 3 shows an example of a detailed configuration of the process device 1-3, as an example of one of the plurality of process devices shown in FIG. 2. In the example shown in the drawing, the process device 1-3 includes, as its key constituents: a chamber 10, a wafer stage 11, a wafer 12, a target 13, an ion reflector 14, a magnet 15, a control monitor unit 20, a DC (Direct Current) power supply unit 21, a gas supply unit 22, a gas flow control unit 23, a pressure detection unit 24, a heater control unit 25, an RF (Radio Frequency) power supply unit 26, a temperature detection unit 27, an electrostatic chuck unit 28, a dry pump 29, a turbomolecular pump 30, a dry pump 31, an IR (Ion Reflector) power supply unit 32, a communication unit 33, and a timer 34.

The chamber 10 is a hollow vessel structured with, for example, quarts, stainless steel, aluminum, copper, alumina, titanium, etc., for isolating the chamber's internal from the atmosphere so as to maintain a high-vacuum internal environment for the corresponding process.

The wafer stage 11 is a stage for placing the wafer 12 on it. On the upper part of the wafer stage 11 (a higher position in the drawing), there is provided an electrostatic chucking mechanism (not shown) for chucking the wafer 12 with electrostatic force. Inside the wafer stage 11, there are provided a heater and a sensor for temperature detection (both are not shown).

The wafer 12 as an objective workpiece is a silicon substrate, for example. In this device, wiring of copper is formed on the silicon substrate by means of PVD.

The target 13 is made of, for example, a copper plate. As argon plasma hits the target 13, constituent particles recoil and eventually get deposited on the wafer 12.

The ion reflector 14 is a cylindrical member configured so as to surround the target 13 and the wafer stage 11. The ion reflector 14 includes a function of reflecting (accelerating) an ion by providing a electrical repulsive force for the ion.

The magnet 15 is placed above the target 13, and it includes a function for increasing an efficiency of emission of copper particles out of the target 13 by imposing a Lorentz force on an argon ion in the plasma so as to accelerate the ion.

The control monitor unit 20, as a first acquisition means, a second acquisition means and a part of a correlation means, is configured with a micro computer including a CPU (Central Processing Unit), a ROM (Read Only Memory), a RAM (Random Access Memory), and so on. The control monitor unit 20 controls each part of the device according to a program saved in the ROM, and generates log data to transmit the data to the log storage device 2 through the communication unit 33 and the network 3.

The DC power supply unit 21 applies a DC voltage between the target 13 and the ground in such a way that the target 13 and the ground become negative and positive respectively. It makes the argon gas charged in the space between the target 13 and the wafer 12 to plasma.

The gas supply unit 22 supplies argon gas into the chamber 10 via the gas flow control unit 23.

The gas flow control unit 23, being configured, e.g., with a mass flow controller, controls a flow rate of the gas supplied from the gas supply unit 22 in accordance with a control of the control monitor unit 20. Meanwhile, it also notifies the control monitor unit 20 of the gas flow rate at the time.

The pressure detection unit 24, being configured, e.g., with an ion gauge, a Pirani gauge, or else, measures an internal pressure of the chamber 10, and notifies the control monitor unit 20 of the measure result.

The heater control unit 25 controls a heater built in the wafer stage 11 in accordance with a control of the control monitor unit 20, so as to set the temperature of the wafer 12 as required.

The RF power supply unit 26 applies a high-frequency power between the ground and the wafer stage for imposing an RF bias on the wafer 12 so that the wafer 12 is charged negatively and an attractive force is generated between the a copper ion having a positive electric charge and the wafer 12. Thus, the copper ion collides with the wafer 12 at high speed, and then the copper ion reaches a deep part of a concave portion formed in the wafer 12.

The temperature detection unit 27 detects the temperature of the wafer stage 11, and notifies the control monitor unit 20 of the detection result.

The electrostatic chuck unit 28 controls the electrostatic chucking mechanism placed in the wafer stage 11 in accordance with a control of the control monitor unit 20, for fixing the wafer 12 by sucking it.

The dry pump 29 evacuates the air existing inside the chamber 10 to the exterior in accordance with a control of the control monitor unit 20, for making the interior of the chamber vacuum.

The turbomolecular pump 30 achieves a higher vacuum than the dry pump 29 does, and it evacuates the gas existing inside the chamber 10 to the exterior.

The dry pump 31 is connected to an exhaust side of the turbomolecular pump 30 for evacuating the gas discharged from the turbomolecular pump 30 to the exterior so as to increase efficiency of the turbomolecular pump 30.

The IR power supply unit 32 applies a DC voltage according to a control of the control monitor unit 20 in such a way that the ion reflector 14 and the ground become positive and negative respectively to reflect (accelerate) copper ions by the ion reflector 14.

The communication unit 33 controls communications between the log storage device 2 and the control monitor unit 20 via the network 3 in accordance with the communication protocol.

The timer 34 as a part of a correlation means generates information such as date-and-hour information (including data on the year, date, and hour), and supplies the information to the control monitor unit 20. The control monitor unit 20 makes use of the date-and-hour information generated by the timer 34, as a time stamp.

The process device 1-8 is configured in the same way as the process device 1-3. In the process devices 1-1 and 1-10, a wafer placed in a chamber is heated and hydrogen gas is introduced into the chamber so that a native oxidation film formed on a surface of the wafer is removed through reduction by hydrogen gas. In the process devices 1-2 and 1-9, tantalum or the like is deposited on a surface of a wafer by means of PVD for the purpose of improving adhesion between copper and silicon dioxide as well as preventing copper from diffusing into a silicon dioxide insulation film. As shown in FIG. 3, each of these devices is configured to include a chamber in which a process is executed, a control monitor unit, a communication unit, a timer, and other sections required. Then, when the chambers, the control monitor units, the communication units, and the timers of the process devices are referred to individually in the following explanation, they are called the chambers 10-1 to 10-10, the control monitor units 20-1 to 20-10, the communication units 33-1 to 33-10, and the timers 34-1 to 34-10, respectively. Incidentally, when the process device 1-3 is referred to, “-3” is omitted.

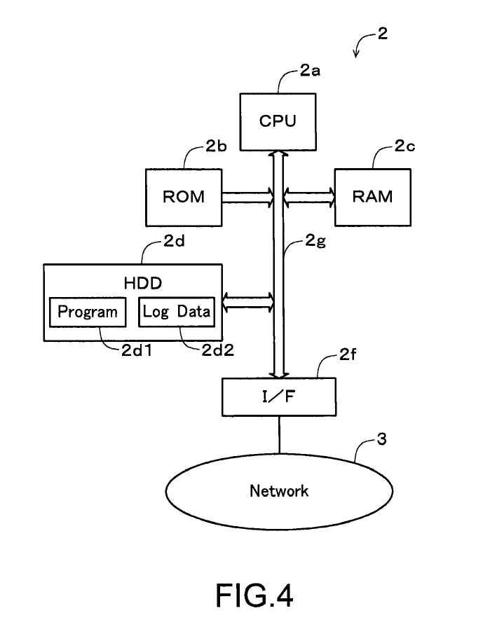

FIG. 4 is a block diagram showing an example of a detailed configuration of the log storage device 2 shown in FIG. 1. As shown in the diagram, the log storage device 2 includes, as its key constituents: a CPU 2a, a ROM 2b, a RAM 2c, an HDD (Hard Disk Drive) 2d, an I/F (Interface) 2f, and a bus 2g.

The CPU 2a, as an adjusting means, controls each part of the device in accordance with a program 2d1 saved in the HDD 2d and another program (not shown) saved in the ROM 2b, and then executes various calculating operations. Furthermore, in accordance with the program 2d1 saved in the HDD 2d, the CPU 2a acquires log data from the process device 1 and stores the log data. Then, the CPU 2a reads and supplies log data according to a demand from the analysis device 4.

The ROM 2b is a semiconductor storage device that stores a basic program and data to be executed by the CPU 2a. The RAM 2c is another semiconductor storage device that temporarily stores a program and data to be executed by the CPU 2a.

The HDD 2d, as a storage means, is a storage device in which information is saved in a hard disk, as a magnetic storage medium, and saved information is contrarily read out of the hard disk. In this example case, the HDD 2d saves the program 2d1 and a log data 2d2. The program 2d1 here saves a program such as an operating system for controlling the log storage device 2, as well as an application program for acquiring and storing log data. The log data 2d2 stores log data acquired from the process device 1 by the application program that is booted by execution of the program 2d1.

The I/F (interface) 2f executes a procedure in relation to a protocol at the time of sending/receiving information to/from the process device 1 via the network 3. The bus 2g is a group of signal wires that electrically connects the CPU 2a, the ROM 2b, the RAM 2c, the HDD 2d, and the I/F 2f one another for making it possible to send/receive information among them.

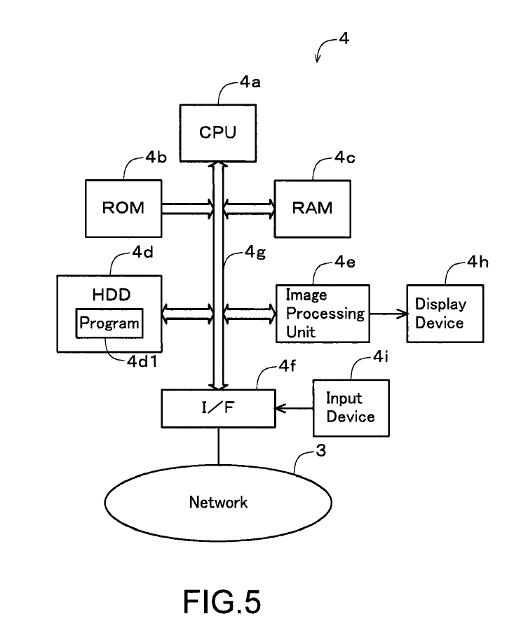

FIG. 5 is a diagram showing an example of a detailed configuration of the analysis device 4 shown in FIG. 1. As shown in the diagram, the analysis device 4 includes, as its key constituents: a CPU 4a, a ROM 4b, a RAM 4c, an HDD 4d, an image processing unit 4e, an I/F 4f, a bus 4g, a display device 4h, and an input device 4i.

The CPU 4a, as an analysis means, controls each part of the device in accordance with a program 4d1 saved in the HDD 4d and another program saved in the ROM 4b, and executes various calculating operations. Furthermore, in accordance with the program 4d1, the CPU 4a acquires log data stored in the log storage device 2, and executes analysis operations.

The ROM 4b is a semiconductor storage device that stores a basic program and data to be executed by the CPU 4a. The RAM 4c is another semiconductor storage device that temporarily stores a program and data that are processing objects for the CPU 4a. Furthermore, the RAM 4c stores the acquired log data as well as analysis condition data.

The HDD 4d is a storage device in which information is written into a hard disk, as a magnetic storage medium, and written information is contrarily read out of the hard disk. In this example case, the program 4d1 is stored in the HDD 4d. The program 4d1 here includes a program such as an operating system for controlling the analysis device 4, as well as an application program for acquiring and analyzing log data.

The image processing unit 4e executes graphic processing according to a plotting command supplied from the CPU 4a, then converts an obtained image into a video signal, and supplies the video signal to the display device 4h. The I/F 4f converts an image representation format of data at the time of sending/receiving information between the input device 4i and the network 3. The bus 4g is a group of signal wires that electrically connects the CPU 4a, the ROM 4b, the RAM 4c, the HDD 4d, the image processing unit 4e, and the I/F 4f one another for making it possible to send/receive information among them.

The display device 4h, as a presentation means, is configured, for example, with either an LCD (Liquid Crystal Display) or a CRT (Cathode Ray Tube), or else, and the display device 4h displays an image on a display unit (not shown) according to a video signal supplied from the image processing unit 4e.

The input device 4i is configured, for example, with a keyboard, a mouse, and so on. According to an operation by an administrator of a vacuum process management system, the input device 4i generates information and supplies it to the CPU 4a via the I/F 4f.

(B) Outline of Operation of Embodiment,

In a vacuum process management system according to the present embodiment, as a processing operation for the wafer 12 starts in the process devices 1-1 to 1-10, each of the control monitor units 20-1 to 20-10 controls each part of the corresponding device (the DC power supply unit 21, the gas flow control unit 23, and so on) for the process execution in accordance with a control program preset in advance. At the time, the control monitor units 20-1 to 20-10 generate data (event data), being as control information, in relation with the control operation, add an ID (hereinafter to be called a “wafer ID”) for identifying the wafer 12 of the processing object, and attach a time stamp supplied from the timers 34-1 to 34-10. Furthermore, the control monitor units 20-1 to 20-10 acquire data (trace data), being as state information for showing the state of each part of the devices, in a predefined cycle period (for example, with a cycle period of 0.1 seconds), and attach the time stamp supplied from the timers 34-1 to 34-10. Then, the control monitor units 20-1 to 20-10 send the information, as log data, to the log storage device 2.

The log storage device 2 receives the log data supplied from the process devices 1-1 to 1-10, adjusts the log data according to a cycle period predefined for each of the process devices, and then stores the log data, which has been acquired and then adjusted, as the log data 2d2 into the HDD 2d. More specifically to describe, the log storage device 2 adjusts the log data with a cycle period of 1 second for the process devices 1-1, 1-5, 1-6, and 1-10 since changes in the processes of the chambers of these process devices are made slowly, meanwhile the log storage device 2 adjusts the log data with a cycle period of 0.1 seconds for the process devices 1-2, 1-3, 1-8, and 1-9 since changes in the processes of the chambers of these process devices are made quickly. In the present embodiment, the process devices 1-1 to 1-10 generate and send log data with a cycle period of 0.1 seconds, and therefore the log storage device 2 executes decimation for the trace data sent from the process devices 1-1, 1-5, 1-6, and 1-10 so as to make the cycle period 1 second, meanwhile, for event data, the log storage device 2 makes an adjustment of the time stamp, for example, by rounding off to the 1-second period so as to make the cycle period 1 second. On the other hand, the log data received from the process devices 1-2, 1-3, 1-8, and 1-9 is stored as it is.

Then, for example, if the wafer 12 manufactured has any defect, an administrator for the vacuum process management system (hereinafter, to be simply called “the administrator”) operates the input device 4i of the analysis device 4 for acquiring the log data 2d2 stored in the log storage device 2, executes the analysis, and identifies a cause of the defect through analyzing various viewpoints.

The analysis device 4 downloads the designated trace data and log data into the RAM 4c. Then, the analysis device 4 carries out an operation of correlating the downloaded trace data with the event data with reference to a time stamp. The event data here includes, for example, data showing a start of supplying of gas from the gas supply unit 22, a wafer ID of the wafer 12 of the processing object, and a time stamp showing the time and date when the gas supply has started. The trace data includes data showing a gas flow rate at each timing and data of a time stamp at the timing. The analysis device 4 associates two sets of data on a time axis, by correlating a set of event data with a set of trace data that are provided with the same time stamp attached.

Then, the administrator operates the input device 4i of the analysis device 4 to enter analysis conditions, and executes the analysis according to the corresponding analysis conditions. Then, the administrator operates the input device 4i of the analysis device 4 to execute the analysis. Eventually, the analysis device 4 executes the analysis processing according to the entered analysis conditions.

By referring to the information indicated, the administrator can identify a cause of the defect. Furthermore, the administrator can prevent the same defect from coming up again by modifying the control program, which is stored in the control monitor units 20-1 to 20-10, while taking into account the identified cause of the defect.

(C) Detailed Operation of Embodiment

The detailed operation of the embodiment according to the present invention will be described. The process devices 1-1 and 1-3 are taken up by example in the following explanation. The explanation below is made in order of: (C-1) Event data generating procedure in the process devices 1-1 and 1-3, (C-2) Trace data generating procedure in the process devices 1-1 and 1-3, (C-3) Log data storing procedure in the log storage device 2, and (C-4) Analyzing procedure in the analysis device 4.

(C-1) Event Data Generating Procedure in the Process Devices 1-1 and 1-3

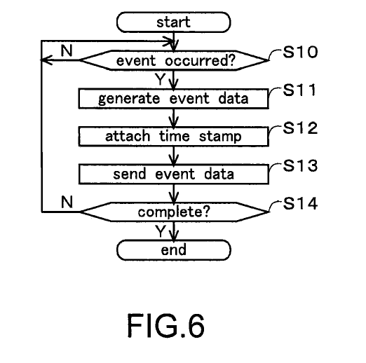

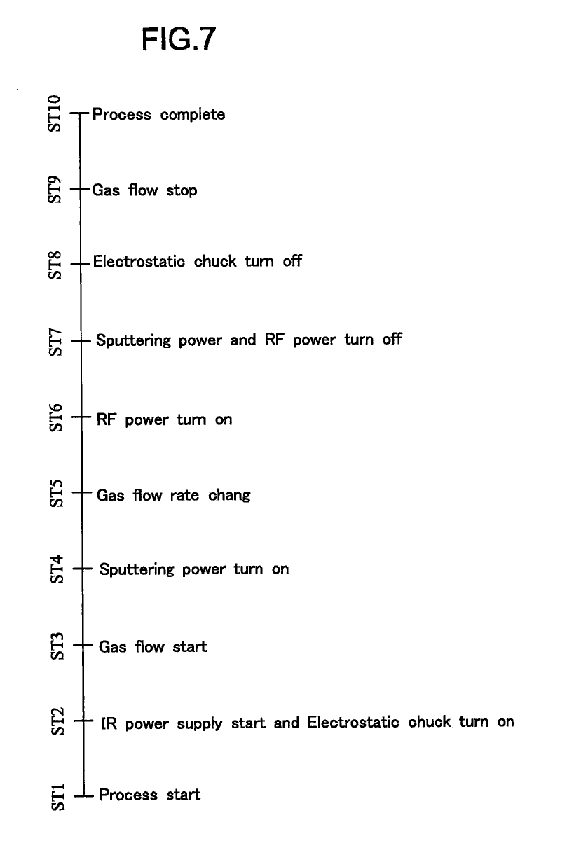

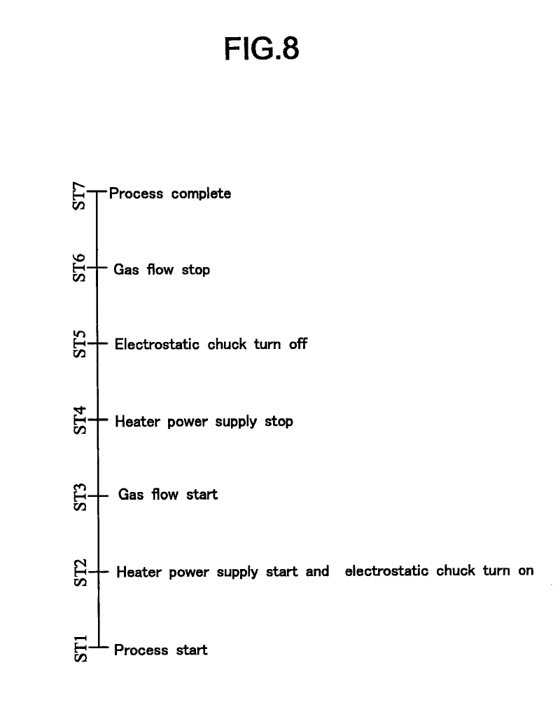

FIG. 6 is an example of a flowchart showing details of a procedure for generating event data in the process devices 1-1 and 1-3 shown in FIG. 2. Before explaining the flowchart shown in FIG. 6, events to be occurred in the process devices 1-1 and 1-3 are individually described with reference to FIGS. 7 and 8.

In the process device 1-3, plasma generated by argon gas sputters the copper of the target 13 to deposit it onto the wafer 12. After the wafer 12 is placed on the wafer stage 11 in the chamber 10, the dry pump 29 is operated until the interior of the chamber 10 reaches a specified vacuum state. After getting the specified vacuum state, the turbomolecular pump 30 and the dry pump 31 are operated. When the interior of the chamber 10 subsequently reaches a specified vacuum state, a process shown in FIG. 7 starts (ST1: an event of starting a process is occurred).

Next, the control monitor unit 20 controls the IR power supply unit 32 to start the IR power supply, and controls the electrostatic chuck unit 28 to operate the electrostatic chuck mechanism (ST2). Consequently, a DC voltage is applied in such a way that the ion reflector 14 and the ground become positive and negative respectively. The electrostatic chuck unit 28 operates to suck and fix the wafer 12 on the wafer stage 11.

Subsequently, the control monitor unit 20 controls the gas flow control unit 23 to start a gas flow operation (ST3). Consequently, the argon gas supplied from the gas supply unit 22 is controlled on its flow rate by the gas flow control unit 23 and then introduced into the chamber 10.

Next, the control monitor unit 20 controls the DC power supply unit 21 to apply a DC voltage (a sputtering power) in such a way that the target 13 and the ground become negative and positive respectively (ST4: the sputtering power turned on). As a result, grow discharge starts between the target 13 and the wafer stage 11 so that the argon gas becomes a plasma state. Since an atomic core (argon ion) of the argon gas in the plasma state is charged positively, there arises an attracting force between the atomic core and the target on which a negative voltage is applied. Therefore, being attracted to the target to become accelerated, the atomic core collides with the target 13. As a result, a copper molecule jumps out of the copper constituting the target 13, and the copper molecule that has jumped out is deposited on the surface of the wafer 12.

Subsequently, the control monitor unit 20 controls the gas flow control unit 23 to decrease the flow rate of the argon gas (ST5). Then, the control monitor unit 20 controls the RF power supply unit 26 to apply a high-frequency power (an RF power) between the wafer stage 11 and the ground (ST6: turn the RF power on). In the plasma, an electron has a higher mobility than an ion, and therefore an electron gets separated from a copper molecule so as to be ionized (to become a copper ion). Then, the separated electron gathers on the wafer 12 to charge the wafer 12 negatively. Thus, there arises an attracting force electrically between the copper ion charged positively and the wafer 12 charged negatively so that the copper ion is accelerated to collide with the wafer 12. Therefore, the copper ion reaches a deep part of a concave portion formed in the wafer 12. Furthermore, the high-speed collision of the copper ion prevents any copper burr being formed at an opening of the concave portion. Still further, since the motion of the copper ion is faster in a downward direction (a direction toward the wafer 12) in FIG. 3, than in a horizontal direction, it becomes possible to form a homogeneous copper film for an interior of a concave portion provided with a high aspect ratio.

The ionized copper is charged positively so that there arises a repulsive force against the ion reflector 14 charged positively. Accordingly, the copper ion is reflected (accelerated) by the ion reflector 14 so as to come back into the plasma. As a result, efficiency of forming the copper film can be promoted.

When a predetermined time period has passed after the start of sputtering and thickness of the copper film deposited on the wafer 12 reaches a predetermined value, the control monitor unit 20 controls the DC power supply unit 21 to turn off the sputtering power and also controls the RF power supply unit 26 to turn off the RF power (ST7). Thus, the sputtering operation completes.

Subsequently, the control monitor unit 20 controls the electrostatic chuck unit 28 to turn off the electrostatic chuck (ST8). Next, the control monitor unit 20 controls the gas flow control unit 23 to stop the argon gas supply from the gas supply unit 22 (ST9). Then, the control monitor unit 20 completes its process (ST10).

The processing operation for one wafer 12 by the process device 1-3 completes as described above. Afterward, the wafer 12, for which the processing operation has completed, is taken out from the chamber 10, and stored in the stocker 6-2. Furthermore, a wafer, for which a processing operation has completed, is taken out from the chamber 10-5 of the process device 1-5, and the wafer is placed on the wafer stage 11 in the chamber 10 to repeat the same operations as described above.

A processing operation to be executed in the process device 1-1 is briefly explained with reference to FIG. 8.

When a start command is given for a process in the process device 1-1, each wafer 12 is taken out one at a time from the stocker 6-1 where a plurality of wafers 12 are stored, and the wafer 12 is placed on the wafer stage 11-1 in the chamber 10-1. When the interior of the chamber 10-1 reaches a specified vacuum state, the process starts (ST1).

At the time of starting the process, a heater power supply for heating the wafer 12 starts, and an electrostatic chuck for chucking the wafer 12 with an electric force is turned on (ST2).

When the wafer 12 reaches a specified temperature state, a flow of hydrogen gas starts to be introduced into the chamber 10-1 (ST3). Consequently, a native oxidation film formed on a surface of the wafer 12 is deoxidized and removed by the hydrogen gas.

When a predetermined time period has passed after the start of supplying hydrogen gas, the heater power supply for heating the wafer 12 is stopped (ST4). Thus, the temperature of the wafer starts decreasing.

Subsequently, the electrostatic chuck gets turned off (ST5), and supplying the hydrogen gas is stopped (ST6). Thus, the process completes (ST7).

Operations of the processes shown in FIGS. 7 and 8 are just an example, and needless to add, any other operations may be applied.

A procedure for generating event data will be explained with reference to FIG. 6. The event data is generated at the time when the processes described above are individually executed in the process devices 1-1 and 1-3. Since the procedure for generating the event data is almost the same in the process devices 1-1 and 1-3, the procedure in the process device 1-3 is exemplified in the following explanation. When an operation of the flowchart shown in FIG. 6 starts, steps described below are executed.

Step S10: The control monitor unit 20 judges whether or not an event has been occurred. If an event has been occurred, the operation progresses to Step S11, and in any other case, the same steps are repeated. In other words, the control monitor unit 20 executes a control operation according to a control program, which is not shown, to make the operation progress to Step S11 if any event shown in FIG. 7 has been occurred. In any other case, Step S10 is repeated.

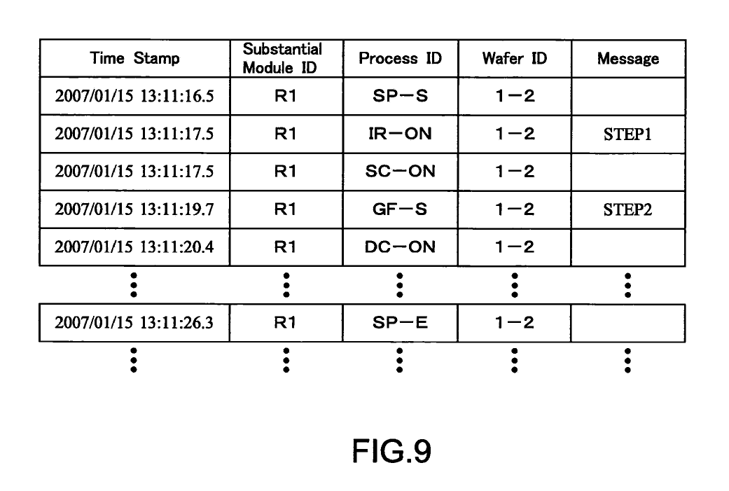

Step S11: The control monitor unit 20 generates event data. FIG. 9 shows an example of such event data. In the example, each one line shows event data of one record. One record of event data includes: a time stamp (details to be described later), a substantial module ID, a process ID, a wafer ID, and a message. The time stamp here is information to be attached in Step S12 to be described later. The substantial module ID, as information for identifying the process device, is an ID for identifying the chamber 10. In the embodiment of FIG. 1, there exist the process devices 1-1 to 1-10, and therefore, each of the multiple chambers is assigned a unique ID. In the present example, “R1” is specified as a chamber ID corresponding to the process device 1-3 (Refer to FIG. 2).

The process ID is an ID for identifying a type of the process. In the present example, there are described “SP-S”, “IR-ON”, “SC-ON”, “GF-S”, and “DC-ON”. “SP-S” here is “Sputtering process start” of ST1 in FIG. 7. “IR-ON” corresponds to “IR power supply start” of ST2 in FIG. 7. “SC-ON” corresponds to “Electrostatic chuck turn ^{on} of ST2 in FIG. 7. “GF-S” is “Gas flow start” of ST3 in FIG. 7. “DC-ON” is “Sputtering power turn on” of ST4 in FIG. 7.

The wafer ID as information for recognizing the processing object is an ID for identifying the wafer 12. A numeral before the hyphen is a value for identifying the wafer cassette (lot). Meanwhile, a numeral after the hyphen is a value for indicating the processing order in the wafer cassette (a slot in the wafer cassette). In the present example, all the event data relates to one and the same wafer 12, and therefore, a wafer ID “1-2” is stored for all records of the event data.

The message is additional information to be used in the analysis processing. In the present example, “STEP1”, “STEP2”, and so on are provided as the message.

In Step S11, “Process ID” is generated in accordance with the event among the information of one record shown in FIG. 7, “substantial module ID” and “Wafer ID” are added correspondence with the chamber and the wafer respectively, and then, “Message” is added in correspondence with the “Process ID” to finally generate the event data.

Step S12: The control monitor unit 20 acquires date-and-hour information, regarding the time when the event was occurred, from the timer 34, and attaches the information to the event data generated in Step S11. Here at this time, the minimum unit for the date-and-hour information generated by the timer 34 is 1/10 seconds. Therefore, any time period shorter than 1/10 seconds is automatically cut off or rounded off. Concretely to describe, when the date-and-hour information generated by the timer 34 is “2007/01/15 13:11:16.51”, the trailing “1” is rounded off for example to make a time stamp of “13:11:16.5”. Thus, the time unit of the event data agrees with that of the trace data, as to be described later

According to the steps described above, a time stamp including data of “Year”, “Month”, “Date”, and “Time” is added to the event data, as FIG. 9 shows. Concretely to describe, “2007/01/15 13:11:16.5” as a time stamp is added to the event data of the first line in FIG. 9.

Step S13: The control monitor unit 20 sends the event data, generated in Step S12, to the log storage device 2 through the communication unit 33 and the network 3. In the log storage device 2, the event data sent through the network 3 is received by the I/F 2f. Then, after making an adjustment on the cycle period, etc., by means of an operation to be described later, the data is stored in the HDD 2d as the log data 2d2. In the case of the process device 1-3, the cycle period of generating event data is 0.1 seconds, while the cycle period of acquiring event data in the log storage device 2 is also 0.1 seconds. Therefore, no adjustment on the cycle period, etc. is made, and the data is stored in the HDD 2d as the log data 2d2, as it is. As a result, the HDD 2d stores the event data in the format that FIG. 9 shows. As a transmission package unit for sending the event data in Step S13, for example, data of one record may be sent as one unit when the data creation completes. Otherwise, data of a predetermined number of records may also be sent when the data has been collected, or data may as well be collectively sent at a time between a process completion and a next process start (vacant time), as shown in FIG. 7.

Step S14: The control monitor unit 20 judges whether or not the procedure is to complete. If the control monitor unit 20 judges that the procedure is not to complete, the procedure returns to Step S10 to repeat the same steps. Otherwise, the procedure completes. For example, if a command for completing the procedure is issued by the administrator, the procedure completes. Otherwise, the procedure returns to Step S10 to repeat the same steps.

Through the procedure described above, an event log is generated and stored in the HDD 2d of the log storage device 2.

(C-2) Trace Data Generating Procedure in the Process Device 1

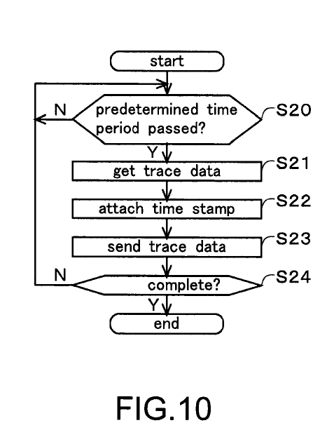

A procedure for generating trace data will be explained with reference to FIG. 10. The procedure is executed at the time when the processes described above are individually executed in the process devices 1-1 and 1-3. The procedure for generating trace data is almost the same in the process devices 1-1 and 1-3, and therefore the operation in the process device 1-3 is exemplified in the following explanation. When the procedure of the flowchart shown in FIG. 10 starts, steps described below are executed.

Step S20: The control monitor unit 20 refers to date-and-hour information generated by the timer 34, and judges whether or not a predetermined time period has passed. For example, referring to date-and-hour information generated by the timer 34, the control monitor unit 20 judges whether or not 1/10 seconds have passed at the time, after completion of the last operation. If the control monitor unit 20 judges that 1/10 seconds have already passed, the operation progresses to Step S21, and in any other case, the same step repeat. More concretely to describe, if the date-and-hour information generated by the timer 34 was “2007/01/15 13:11:16.4” in the last operation and it has now changed to “2007/01/15 13:11:16.5”, the control monitor unit 20 judges that the predetermined time period has already passed and the operation progresses to Step S21. This step may be executed by periodical interruption from the timer 34 (at 1/10 second interval).

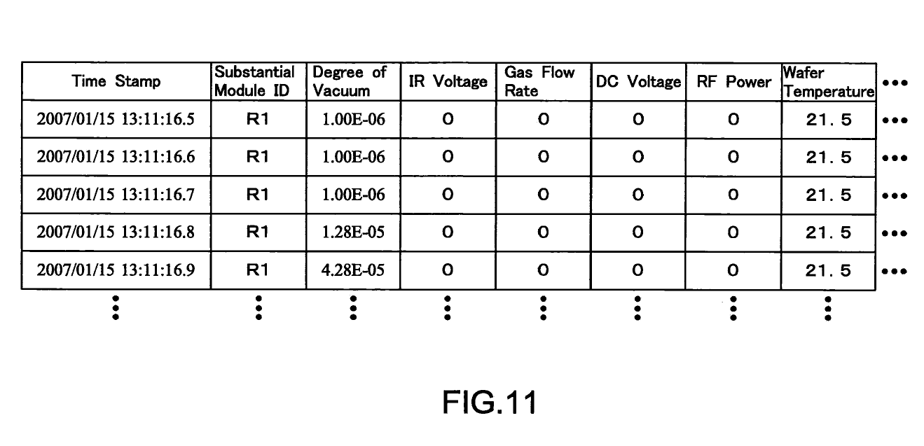

Step S21: The control monitor unit 20 acquires trace data as information showing the state of each part of the process device 1. FIG. 11 shows an example of trace data. In the example, each one line shows trace data of one record. One record of trace data includes: “Degree of Vacuum”, “IR Voltage”, “Gas Flow Rate”, “DC Voltage”, “RF Power”, “Wafer Temperature”, and so on.

“Degree of Vacuum” here is information measured by the pressure detection unit 24 shown in FIG. 3. “IR Voltage” is information showing a voltage value of a DC voltage applied between the ion reflector 14 and the ground by the IR power supply unit 32. “Gas Flow Rate” is information showing a flow amount per unit time of gas supplied from the gas supply unit 22 into the chamber 10 by the gas flow control unit 23. “DC Voltage” is information showing a voltage value of a DC voltage applied between the target 13 and the ground by the DC power supply unit 21. “RF Power” is information showing a voltage value of an AC voltage applied between the wafer stage 11 and the ground by the RF power supply unit 26. “Wafer Temperature” is information showing the temperature of the wafer 12 detected by the temperature detection unit 27. The trace data shown in FIG. 11 is just an example. Any other data format may be applied.

The pieces of information described above are sampled and acquired almost at the same time, and therefore they are information data showing the state of each part of the process device 1-3 at the moment indicated by the time stamp, which is described later.

Step S22: The control monitor unit 20 acquires date-and-hour information of the current time from the timer 34, and attaches it to the trace data acquired in Step S21. Here at this time, the minimum unit for the date-and-hour information generated by the timer 34 is 1/10 seconds, and “2007/01/15 13:11:16.5” for example is attached as a time stamp. Thus, the time unit and the cycle period of the event data described above correspond with those of the trace data.

According to the steps described above, a time stamp including data of “Year”, “Month”, “Date”, and “Time” is added to the trace data, as FIG. 11 shows. Concretely to describe, “2007/01/15 13:11:16.5” as a time stamp is added to the trace data shown in the first line of FIG. 11, which agrees with the time stamp shown in the first line of FIG. 9.

Step S23: The control monitor unit 20 sends the trace data, to which the time stamp has been attached in Step S22, to the log storage device 2 through the communication unit 33 and the network 3. In the log storage device 2, the trace data sent through the network 3 is received by the I/F 2f. Then, after making an adjustment on the cycle period, the data is stored in the HDD 2d as the log data 2d2. In the case of the process device 1-3, the cycle period of generating trace data is 0.1 seconds, while the cycle period of acquiring trace data in the log storage device 2 is also 0.1 seconds. Therefore, no adjustment on the cycle period, etc. is made, and the data is stored in the HDD 2d as the log data 2d2, as it is. As a result, the HDD 2d stores the trace data in the format that FIG. 11 shows. As a transmission package unit for sending the trace data in Step S23, for example, data of one record may be sent as one unit when the data creation completes. Otherwise, data of a predetermined number of records may also be sent when the data has been collected, or data may as well be collectively sent at a time between a process completion and a next process start (vacant time), as shown in FIG. 7.

Step S24: The control monitor unit 20 judges whether or not the procedure is to complete. If the control monitor unit 20 judges that the procedure is not to complete, it returns to Step S20 to repeat the same steps, and otherwise, the procedure completes. For example, if a command for completing the procedure is issued by the administrator, the procedure completes, and otherwise, the procedure returns to Step S20 to repeat the same steps.

Through the steps described above, trace data is generated, and stored in the HDD 2d of the log storage device 2.

(C-3) Log Data Storing Procedure in the Log Storage Device 2

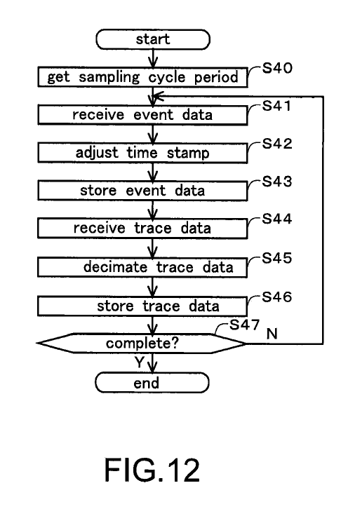

A procedure for storing log data will be explained with reference to FIG. 12. This procedure is to be executed by the log storage device 2. When the procedure starts, steps described below are executed.

Step S40: The CPU 2a of the log storage device 2 acquires the sampling cycle period of each process device, which is stored in the HDD 2d. Concretely to describe, in the example of FIG. 2, the sampling cycle period of the process devices 1-1, 1-5, 1-6, and 1-10 is 1 second, while that of the process devices 1-2, 1-3, 1-8, and 1-9 is 0.1 second. Information showing the sampling cycle period of each process device is stored in the HDD 2d, and the log storage device 2 acquires the information.

Step S41: The CPU 2a receives event data sent from each of the process devices 1-1 to 1-10. Each of the process devices 1-1 to 1-10 sends the event data according to the procedure shown in FIG. 6 described above. Meanwhile, since event data is generated with the cycle period of 0.1 seconds, a time interval of event data that the log storage device 2 receives is 0.1 seconds.

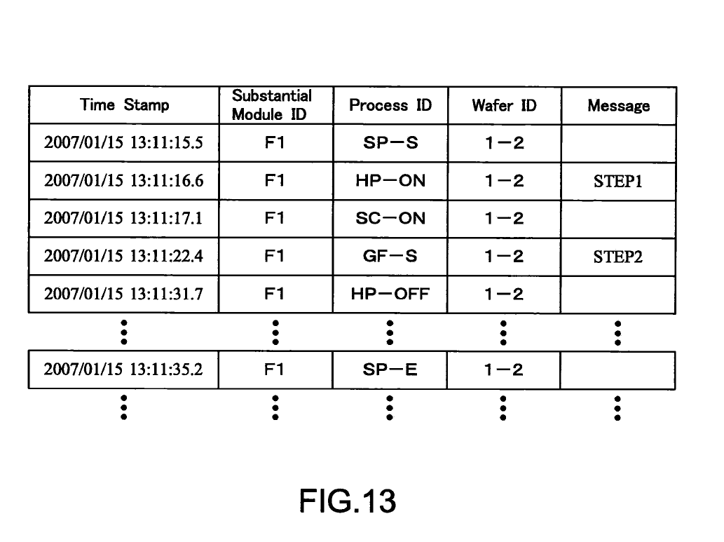

Step S42: The CPU 2a refers to the sampling cycle period of each process device acquired in Step S40 and makes an adjustment on the time stamp. Concretely to describe, in the case of the process device 1-3, event data is generated by 0.1 seconds, while the sampling cycle period is also 0.1 seconds. Therefore, no adjustment is made on the time stamp. The same explanation can be applied for the process devices 1-2, 1-8, and 1-9 as well. On the other hand, in the case of the process device 1-1, event data is generated by 0.1 seconds, while the sampling cycle period is 1 second. Therefore, an adjustment is made on the time stamp. FIG. 13 is an example of event data generated by the process device 1-1. In this example, the time stamp is generated by 0.1 seconds. The CPU 2a rounds off the digit of tenth seconds of the time stamp of the event data received. Concretely to describe, in the case of the time stamp of the record of the first line “2007/01/15 13:11:15.5”, the trailing “0.5” is rounded off to make a time stamp of “2007/01/15 13:11:16.0”. For the other records, the same adjustment with rounding off is made on their time stamps.

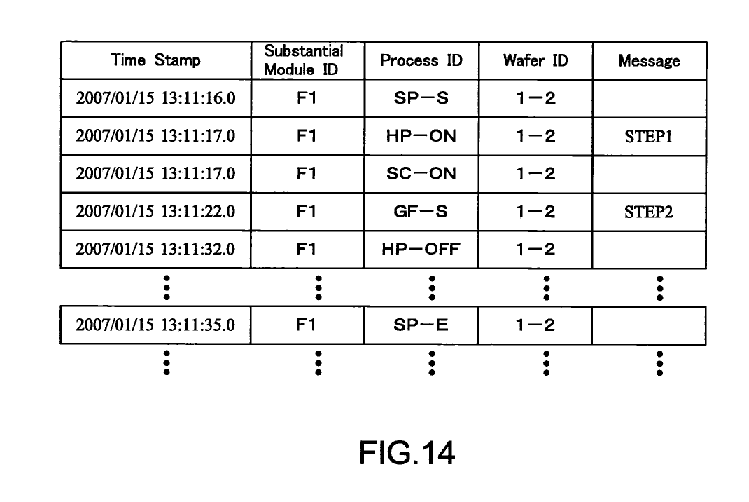

Step S43: The CPU 2a stores the event data, for which an adjustment on the time stamp has been made in Step S42, into the HDD 2d. As a result, the HDD 2d stores the data shown in FIG. 9 as event data for the process device 1-3, and meanwhile the HDD 2d also stores the data shown in FIG. 14 as event data, for which an adjustment has been made on the time stamps, for the process device 1-1.

Step S44: The CPU 2a receives trace data sent from each of the process devices 1-1 to 1-10. Each of the process devices 1-1 to 1-10 sends the trace data according to the procedure shown in FIG. 10 described above. Meanwhile, since trace data is generated at the cycle period of 0.1 seconds as described above, a time interval of trace data that the log storage device 2 receives is 0.1 seconds.

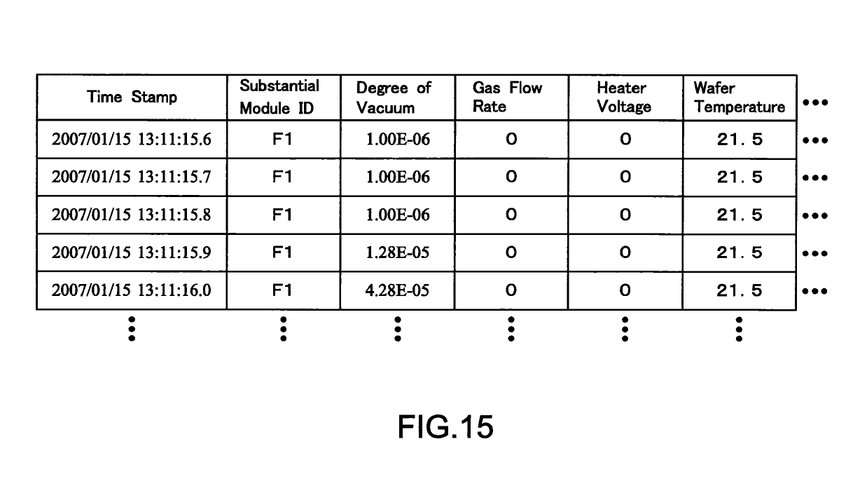

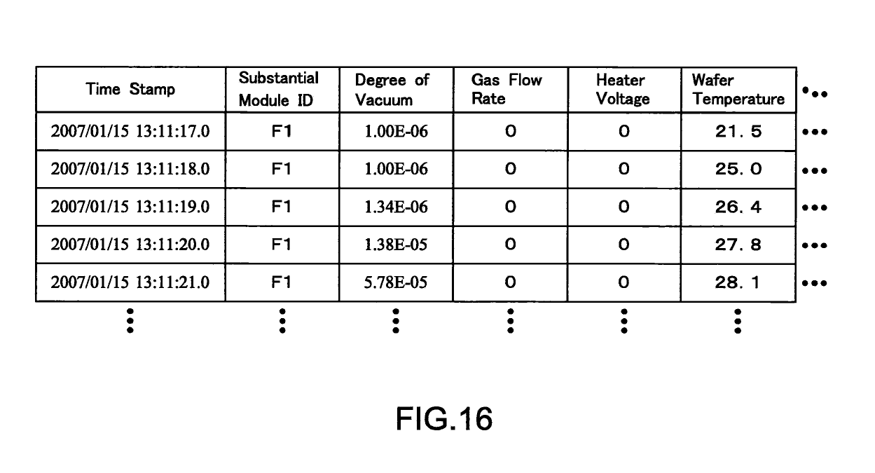

Step S45: The CPU 2a refers to the sampling cycle period of each process device acquired in Step S40, and executes decimation for the trace data. Concretely to describe, in the case of the process device 1-3, event data is generated by 0.1 seconds, while the sampling cycle period is also 0.1 seconds. Therefore, no decimation processing is executed. The same explanation can be applied for the process devices 1-2, 1-8, and 1-9 as well. On the other hand, in the case of the process device 1-1, trace data is generated by 0.1 seconds, while the sampling cycle period is 1 second. Therefore, decimation is executed. FIG. 15 is an example of trace data generated by the process device 1-1. In this example, the time stamp is generated by 0.1 seconds. The CPU 2a executes decimation to have the time stamp of the received trace data on a one-second time scale, namely, in such a way that only trace data, having “0” for the digit of 1/10 seconds of the time stamp, remains and any other trace data is decimated. Concretely to describe, in the case of the example shown in FIG. 15, the record of the fifth line having the time stamp “2007/01/15 13:11:16.0” is acquired, and other records are decimated (excluded). As a result, trace data after the decimation is a group of data in which the digit of 1/10 seconds of the time stamp is “0”, as FIG. 16 shows

Step S46: The CPU 2a stores the trace data, for which decimation been executed in Step S45, into the HDD 2d. As a result, the HDD 2d stores the data shown in FIG. 11 as trace data, and the data shown in FIG. 16 as trace data, for which decimation has been executed, for the process device 1-3 and the process device 1-1, respectively.

Step S47: The CPU 2a judges whether or not the procedure is to complete. If the CPU 2a judges that the procedure is not to complete, the procedure returns to Step S41 to repeat the same steps. Otherwise, the procedure completes.

The event data and trace data generated according to the procedures described above is stored in the log storage device 2, for example, for about 2 months, and then after the 2-month storage period, the data may be deleted in due order from the HDD 2d. On that occasion, data to be deleted can be determined easily by referring to the time stamp. The data storage period may be specified according to a time span within which it becomes clear whether the wafer 12 has any defect or not. For example, in a case where a defect, if any, appears within one month for example, the data should be stored for about 2 months for example. In a case where such a defect appears within 3 months for example, the data should be stored for about 4 months for example. Needless to add, any other appropriate data storage period may be applied.

(C-4) Analyzing Procedure in the Analysis Device 4

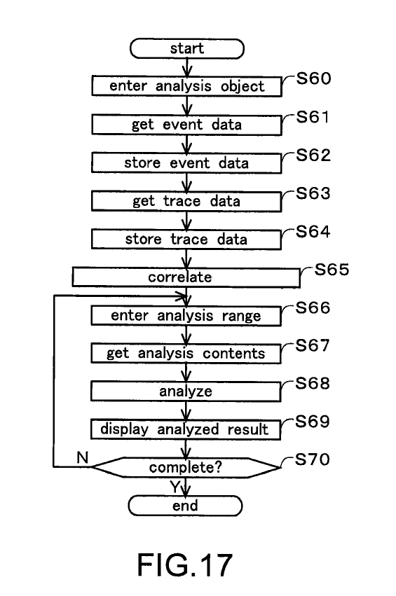

Analyzing procedure executed in the analysis device 4 shown in FIG. 5 will be explained with reference to FIG. 17. The procedure shown as a flowchart of FIG. 17 is executed when the administrator starts an application program for the analyzing procedure included in the program 4d1 through operating the input device 4i of the analysis device 4. When the procedure starts, steps described below are executed.

Step S60: The CPU 4a receives data entered regarding an analysis object. In other words, the CPU 4a receives information generated through operation of the input device 4i carried out by the administrator. Data to be entered as the analysis object are, for example, a substantial module ID as information for identifying a chamber to be analyzed and a wafer ID for identifying a wafer to be analyzed. Then, the type of trace data to be analyzed is entered.

It is also possible to enter a plurality of IDs, in place of a substantial module ID or a wafer ID, and to enter IDs within a certain range. Concretely to describe, for example in the case of substantial module IDs, it is possible to specify a plurality of modules, such as F1, F2, and F5, or to specify a range of modules, such as F1 to F4. Furthermore, for example in the case of wafer IDs, it is possible to specify a range of slots, such as 1-1 to 1-25, to specify a range of lots, such as 1-1 to 10-1, or to specify ranges of both lots and slots, such as 1-1 to 10-25. Moreover, for example, it is also possible to specify a specific range by using a wild card. Concretely to describe, arbitrary slots included in the lot “1” may be specified by setting “1-?”.

As trace data, an individual item such as “Degree of vacuum”, “IR voltage”, or “DC voltage” may be specified. Multiple items may also be specified collectively.

Step S61: The CPU 4a of the analysis device 4 acquires the event data, specified in Step S60, from the log storage device 2. Namely, the CPU 4a requests the log storage device 2 to send the specified event data of the process device through the I/F 4f and the network 3. As a way of specifying the event data at this time, a substantial module ID can be used as described above. The CPU 2a of the log storage device 2 receives the request through the I/F 2f, acquires the specified event data out of the log data 2d2 stored in the HDD 2d, and then sends the data via the I/F 2f. As a result, the CPU 4a of the analysis device 4 receives the event data through the I/F 4f.

Step S62: The CPU 4a stores the event data, received in Step S61, into a prescribed area in the RAM 4c.

Step S63: The CPU 4a acquires the specified trace data from the log storage device 2. Namely, the CPU 4a requests the log storage device 2 to send the trace data through the I/F 4f and the network 3. As a way of specifying the trace data at this time, a substantial module ID can be used as described above. The CPU 2a of the log storage device 2 receives the request through the I/F 2f, acquires the specified trace data out of the log data 2d2 stored in the HDD 2d, and then sends the data via the I/F 2f. As a result, the CPU 4a of the analysis device 4 receives the trace data through the I/F 4f.

Step S64: The CPU 4a stores the trace data, received in Step S63, into a prescribed area in the RAM 4c.

Step S65: The CPU 4a correlates the event data with the trace data, being stored in the RAM 4c, by referring to the corresponding time stamp attached to each record. Namely, the CPU 4a correlates the event data with the trace data, wherein a time stamp with the same date-and-hour information is attached to each of the event data and the trace data.

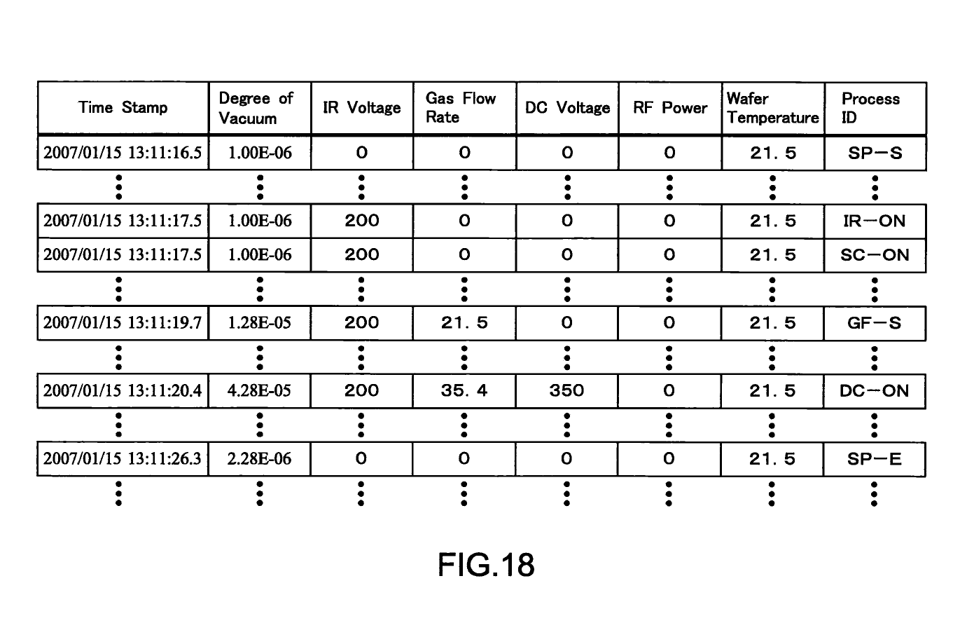

In the process device 1-3, trace data is periodically sampled at 0.1 second intervals, and meanwhile, event data is generated when an event is occurred, and accordingly the event data is non-periodical data. Therefore, correlating these two types of data leads to a result shown in FIG. 18. The example shown in FIG. 18 is an outcome of correlating the process ID shown in FIG. 9 with the trace data shown in FIG. 11. A group of dots placed between two lines mean that trace data between the two lines is omitted.

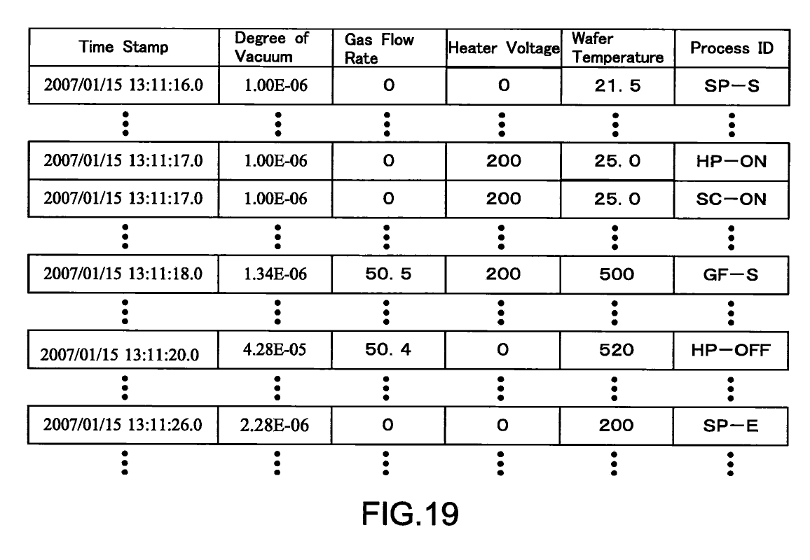

FIG. 19 shows a result of correlating trace data with event data of the process device 1-1. The example shown in FIG. 19 is an outcome of correlating the process ID shown in FIG. 14 with the trace data shown in FIG. 16. A group of dots placed between two lines mean that trace data between the two lines is omitted, in the same manner as shown in FIG. 18.

Thus, as a result of correlating trace data with event data by referring to the corresponding time stamp, the trace data is labeled. Then, by using the labeled trace data, analyzing procedure on the data can be carried out easily and quickly, as described later.

Step S66: The CPU 4a receives data entered regarding an analysis range. In other words, the CPU 4a receives information generated through operation of the input device 4i carried out by the administrator. For defining the analysis range, it is possible to specify, for example, a start point and an end point of the analysis range directly according to event data, like specifying data of a time interval from the process start (ST1 in FIG. 7 or ST1 in FIG. 8) until the process completion (ST10 in FIG. 7 or ST7 in FIG. 8), or to specify a start point and an end point of the analysis range by making use of the event data indirectly, like specifying data of a time interval from timing of having spent 1 second after the start of gas flow until timing of the change of gas flow rate (ST5 in FIG. 7) (or, having spent 2 seconds after the change of gas flow rate). It is also possible to specify a start point and an end point of the analysis range by making use of both event data and trace data, like specifying data of a time interval from the sputtering power turned on (ST4 in FIG. 7) until the DC voltage having reached a prescribed voltage.

Step S67: The CPU 4a receives data entered regarding analysis contents. In other words, the CPU 4a receives information generated through operation of the input device 4i carried out by the administrator. The analysis contents may be, sampling trace data, calculating a maximum value, a minimum value, an average, and a medium value of trace data, or comparing trace data (for example, calculation of a correlation function), with reference to the analysis object entered in Step S60 and the analysis range entered in Step 66.

In addition to the analysis contents described above, the entered data may be for calculating, for example, timing of when trace data has a prescribed value or greater (or, a prescribed value or smaller), a time while trace data is within a prescribed range, or a value of trace data at the time when a prescribed time has passed.

In addition to the information described above, the entered data may include information on how an acquired analysis result is output. For example, when the acquired result is output as a file or a graph (to be displayed on a screen or printed out) in a specified format, the format can be specified.

Step S68: The CPU 4a executes analysis on the event data and the trace data correlated in Step S65 according to the information entered in Step S65 to S67.

Concretely to describe for example, the analysis is executed on a time period where the DC voltage is within a range from 400 to 450 in a time span from DC-ON (ST4 in FIG. 7) to DC-OFF (ST7 in FIG. 7) for the wafer 12 processed in a chamber whose substantial module ID is “R1”. In this case, at first among the event data, the CPU 4a searches for a record whose substantial module ID is “R1”. As a result, the data of FIG. 9 is acquired since the data shown in FIG. 9 meets the condition.

Next, in the data acquired, the CPU 4a searches for “DC-ON”, which is a process ID corresponding to DC-ON, and “DC-OFF”, which is a process ID corresponding to DC-OFF. Subsequently, the CPU 4a acquires a time stamp attached to the event data of each of the process IDs “DC-ON” and “DC-OFF”.

Then, the CPU 4a acquires trace data of the DC voltage included in the time period defined by the two time stamps acquired. In other words, out of the trace data shown in FIG. 18, the CPU 4a acquires trace data in terms of the DC voltage included in a time period, wherein the time period is defined by using the two time stamps, described above, as a start point and an end point. Acquired according to the procedures described above is the trace data in terms of the DC voltage within the specified time period regarding the specified wafer coming from the specified chamber.

In the above example, trace data regarding the wafer 12 of one wafer piece is acquired. If there exist a plurality of wafer objects, the steps described above should be repeated for each of the wafers. If a multiple sets of trace data are objective, a group of trace data corresponding to a time period defined by time stamps should be acquired.

When a time period is specified on the basis of a time point having spent a certain time after a prescribed point in trace data, the same steps as described above are executed while the certain time is added to the time stamp of the corresponding trace data, and then the acquired time is used as the reference time point. Concretely to describe, if a time point having spent one second after “GF-S” is specified as a start point of the time period, the start point to be used is “2007/01/15 13:11:20.7”.

In the case where a time period is determined by making use of both event data and trace data, the time period should be determined by using a time point, when the trace data identified by the steps described above meets a prescribed condition, as a start point or an end point.

For calculating a maximum value, a minimum value, an average, and a medium value of the acquired trace data, the maximum value, the minimum value, the average, and the medium value in the acquired trace data should be calculated. For comparing trace data (for example, calculation of a correlation function), the correlation function should be calculated between the sets of trace data themselves.

Step S69: The CPU 4a supplies information, acquired through the analysis in Step S68, to the image processing unit 4e for execution of graphic processing. As a result, an image obtained by the graphic processing is converted into a video signal, then supplied to the display device 4h, and displayed in the display unit that is not shown.

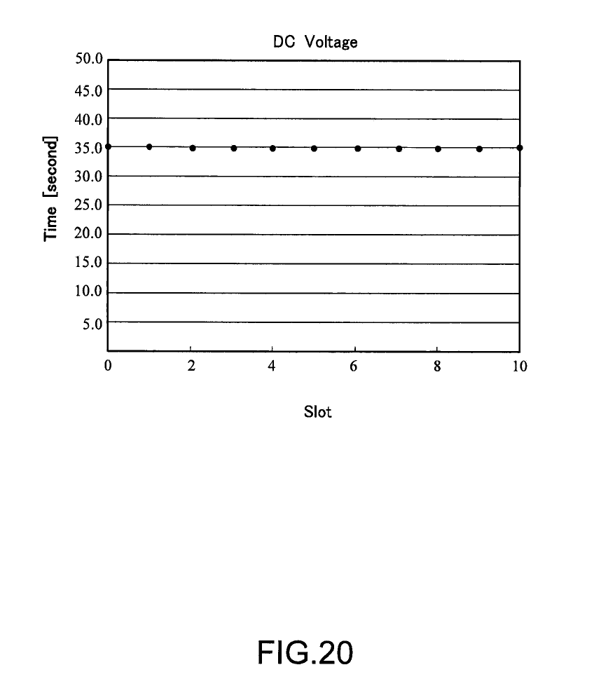

FIG. 20 shows an example of information to be displayed on the display unit of the display device 4h, as a result of the procedure described above. In the example, there is shown a graph in which the horizontal axis and the vertical axis represent slots and the time, respectively. This graph shows that, within an interval from an immediate time point after DC-ON to an immediate time point after DC-OFF, a time period having the DC voltage of 400 to 450 is around 35 seconds, regardless of the slots. By referring to such a graph of an analyzed result, the administrator can make sure of a tendency of the DC voltage. It is also possible to treat data acquired from any other process devices in the same manner and to display the treated result on the display device 4h. Thus, by referring to such information, the administrator can easily and accurately make sure of the process condition of each process device.

Step S70: The CPU 4a judges whether or not the procedure is to complete. If the CPU 4a judges that the procedure is not to complete, the procedure returns to Step S66 to repeat the same steps. Otherwise, the procedure completes. For example, if a command for completing the procedure is issued to the input device 4i by the administrator, the operation completes.

As described above, in the embodiment according to the present invention, a time stamp is independently attached to each of the event data and the trace data, which are then correlated. Then, by using the event data as a trigger, a desired part of the trace data can be acquired so that the data of the desired timing can be searched for quickly.

In the embodiment according to the present invention, a desired scope of the trace data is specified with reference to the event data. Then, the trace data included in the scope is displayed, and analysis processing is carried out for the trace data. Therefore, it is possible to acquire a certain scope of the trace data and to carry out analysis processing for the data quickly and easily.

In the embodiment according to the present invention, the event data is stored, while a wafer ID being attached to the event data. Therefore, the trace data of a specified wafer can be searched for easily and quickly. A symbol showing a lot and a processing order (slot) in the lot is used as the wafer ID, and therefore the trace data of a wafer relating to a specified lot and a specified processing order can be searched for easily and quickly. In the similar way, a substantial module ID for a chamber is attached. Therefore, even though there exist multiple chambers, it is possible to search for the trace data of a desired chamber and to analyze the data quickly and easily.

In the embodiment according to the present invention, the acquired trace data is used for displaying a graph or a calculation result out of calculating a maximum value, a minimum value, an average, and a medium value. Therefore, it is possible to notice quickly a cause of a defect according to the displayed information.

In the embodiment according to the present invention, the trace data and the event data are acquired and stored at a sampling cycle period that is different for each process device. Accordingly, for a process device with a change in the process condition at slow speed, only a small amount of data is prepared so that the amount of log data can be reduced. Furthermore, for a process device with a change in the process condition at high speed, more detailed data analysis enables by making the sampling cycle period shorter.

In the embodiment according to the present invention, for event data and trace data generated in a process device that has a change in the process condition at slow speed, time stamp adjustment and decimation are executed in the log storage device 2 so that a load on the process device can be reduced. Since process device in any case can generate event data and trace data at the same cycle period, it is possible to avoid handful setting individually for each process device.

(D) Modification of the Embodiment

The embodiment described above is a preferred example according to the present invention, but the present invention is not limited to the above example and various variations and modifications may be made without changing the concept of the present invention.

In the embodiment described above, the log storage device 2 is independent from the process devices 1-1 to 1-10. These devices may be integrated. Namely, the log storage device 2 may be structured as a part of the process devices 1-1 to 1-10.

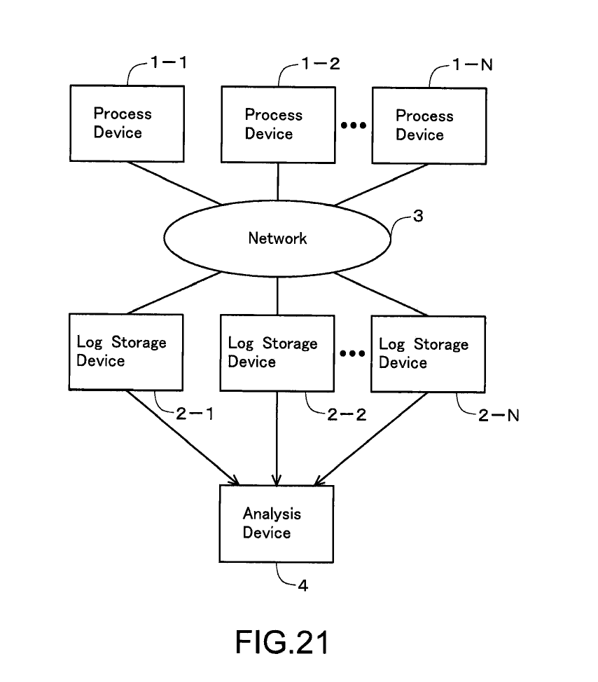

In the embodiment described above, the log storage device 2 is a single device. There may exist multiple devices as the log storage device 2. FIG. 21 shows an example of another embodiment in which there exist N sets of log storage devices 2-1 to 2-N. In the embodiment, log data generated in the process devices 1-1 to 1-N is supplied to and stored in the log storage devices 2-1 to 2-N, respectively. In other words, in this example, each of the log storage devices 2-1 to 2-N acquires a log generated in each corresponding one of the process devices 1-1 to 1-N, executes decimation for the log data with a predefined cycle period, and then stores the data. At the time of analyzing, the analysis device 4 acquires a log data from the log storage devices 2-1 to 2-N and correlates the data for analyzing by referring to a time stamp of the acquired log data for matching operation. While the number of log storage devices being different from the number of the process devices 1-1 to 1-N, a different number of log storage devices 2 may be placed. For example, being compared with the number of the process devices 1-1 to 1-N, a greater number or a smaller number of log storage devices 2 may be placed. As an example of the former case, for example, one log storage device is placed for each process device having a long sampling cycle period in order to save log data, on the other hand, multiple log storage devices (e.g., 2 log storage devices) may be placed for each process device having a short sampling cycle period in order to save log data being divided into some groups. As an example of the latter case, for example, one log storage device (or multiple log storage devices) may be prepared for process devices having a short sampling cycle period, while another one log storage device (or multiple log storage devices) may be prepared for process devices having a long sampling cycle period, in order to save log data separately into different log storage devices, depending on the length of the sampling cycle period. As a precaution against a loss of data, a plurality of log storage devices may be placed for the purpose of multiplexing the log storage device.

In the embodiment described above, the analysis device 4 is independent from the process devices 1-1 to 1-10 as well as the log storage device 2. The analysis device 4 may be structured as a part of the process devices 1-1 to 1-10 or the log storage device 2.

In the embodiment described above, the process devices 1-1 to 1-10, the log storage device 2, and the analysis device 4 are mutually connected one another through the network 3. These devices may be connected directly, not through the network 3. Concretely to describe, these devices can be connected directly by using USB (Universal Serial Bus), or any other interface.

In the embodiment described above, the trace data is always acquired with a constant cycle period, as FIG. 10 shows. The cycle period for acquiring the data may be changed to a different setting, for example, depending on whether the device is in processing operation or not. Concretely describe, while in processing operation, the trace data may be acquired with a shorter cycle period (for example, with a period of 0.1 seconds), and in any other situation, the trace data may be acquired with a longer cycle period (for example, with a period of 1 second). Thus, the amount of trace data can be reduced, and accordingly the required capacity of the HDD 2d can also be reduced.

In the embodiment described above, the event data and the trace data are separately stored. The data may be stored after correlating the data in advance, for example, as shown in FIGS. 18 and 19. According to such an operation, the analysis device 4 does not need to correlate the data so that the latency time for analysis can be shortened.

In the above explanation, there is no description about making use of a message of the event data. The message may be used for specifying a scope of data. Concretely to describe, the messages such as “STEP1” and “STEP2” shown in FIG. 9 may be used for specifying the scope.

In the embodiment described above, the process devices generate the event data and the trace data with a constant cycle period, and meanwhile the log storage device 2 executes the procedures for making an adjustment for the time stamps as well as decimating the data. These procedures may be executed at a side of the process devices, for sending the treated data after the procedures, and meanwhile the log storage device 2 may simply receive and storage the treated data.

In the embodiment described above, the trace data and the event data of each one file are individually handled as objects. The trace data and the event data of multiple files may also be handled as objects. It becomes possible to notice, for example, the change over time by means of analysis processing for data spreading time-wise as objects. If there exists any time-wise-redundant data (i.e., data provided with the same time stamp) at the time of reading the data of multiple files, data processing cannot be done due to the redundant data. Accordingly, there may be an additional step for checking the presence of any time-wise-redundant data in advance for the purpose of having only data without time-wise-redundancy as objects for the data processing.

### INDUSTRIAL APPLICABILITY

The present invention can be applied to a process management system that controls process devices, for example, of a PVD device, a CVD device, and the like.

1. A process management system comprising:
a first acquisition means for acquiring state information showing a state of each part of a plurality of devices;
a second acquisition means for acquiring control information relating to control of the plurality of devices;
an adjustment means for adjusting a cycle period of the state information and the control information, acquired by the first acquisition means and the second acquisition means respectively, to become the same as a cycle period predefined for each device in advance;
a correlation means for correlating the state information with the control information acquired by the first acquisition means and the second acquisition means, respectively;
a storage means for storing the state information and the control information that have been correlated each other by the correlation means;
an analysis means for carrying out prescribed analysis processing on the state information with reference to the control information; and
a presentation means for presenting information obtained as a result of the analysis processing by the analysis means.

2. The process management system according to claim 1;
wherein the correlation means correlates the state information with the control information while providing the state information and the control information with a time stamp individually.

3. The process management system according to claim 2;
wherein the adjustment means makes an adjustment for the state information through decimation on the information so as to provide the cycle period predefined, and an adjustment for the control information on its time stamp so as to provide the cycle period predefined.

4. The process management system according to claim 3;
wherein the first acquisition means acquires the state information with a first cycle period when a semiconductor process device is in execution, and acquires the same with a second cycle period longer than the first cycle period when the semiconductor process device is not in execution.

5. The process management system according to claim 2;
wherein the analysis means executes extraction of a predefined piece of the state information by using a predefined piece of the control information as a trigger; and
the presentation means presents a predefined piece of the state information extracted by the analysis means.

6. The process management system according to claim 2;
wherein the analysis means executes extraction of a predefined piece of the state information by using a predefined piece of the control information as a trigger, and also executes calculation of a time when the predefined piece of the state information extracted meets a predefined condition; and
the presentation means presents the time extracted by the analysis means.

7. The process management system according to claim 2;
wherein the analysis means executes extraction of a predefined piece of the state information by using a predefined piece of the control information as a trigger, and also executes calculation of at least one of a maximum value, a minimum value, an average, and a medium value of the predefined piece of the state information extracted; and
the presentation means presents the value extracted by the analysis means.

8. The process management system according to claim 2;
wherein the storage means stores semiconductor substrate identifying information for identifying a semiconductor substrate as a processing object of the semiconductor process device together with at least one of the control information and the state information; and
the analysis means executes analysis processing with reference to the semiconductor substrate identifying information as well.

9. The process management system according to claim 2;
wherein the semiconductor substrate identifying information includes at least information for identifying a substrate lot of the semiconductor substrate as well as information for identifying a processing order within the lot; and
the analysis means executes analysis processing with reference to the information for identifying the substrate lot of the semiconductor substrate as well as the information for identifying the processing order within the lot.

10. The process management system according to claim 2;
wherein the storage means stores device identifying information for identifying the plurality of devices together with at least one of the control information and the state information; and
the analysis means executes analysis processing with reference to the device identifying information as well.
